(19) United States
(12) Patent Application Publication
(10) Pub. No.: US 2009/0078701 A1
(43) Pub. Date: Mar. 26, 2009

(54) CONTAINER

(76) Inventor: Mauricio D. Cavalcante, Atlanta, GA (US)

Correspondence Address: CARLSON, GASKEY & OLDS, P.C., 400 WEST MAPLE ROAD, SUITE 350, BIRMINGHAM, MI, 48009, US

(21) Appl. No.: 12/236,883

(22) Filed: Sep. 24, 2008

Related U.S. Application Data
(60) Provisional application No. 60/974,553, filed on Sep. 24, 2007.

(51) Int. Cl. B65D 6/16; B65D 6/00; B23P 11/00

(52) U.S. Cl. 220/7; 220/669; 29/428

(57) ABSTRACT

A collapsible container includes a plurality of walls collapsible onto the base. At least one wall has a support pivotably mounted proximate an upper end thereof. The support is pivotable between a support position where it can support another container thereon and a retracted position aligned with the wall. A latch assembly connects the wall to an adjacent wall. A resilient portion of the latch assembly also urges the support from the retracted position toward the support position. When the latch is released, the support can be freely returned to the retracted position against the wall. Therefore, the wall can be collapsed onto the base without having to overcome the force of a biasing member to position the support against the wall.

This application claims priority to U.S. Provisional Application Ser. No. 60/974,553, filed Sep. 24, 2007.

### BACKGROUND OF THE INVENTION

The present invention relates generally to collapsible crates and more particularly to a collapsible crate with support members for supporting another container thereon.

Collapsible crates are well known. Four walls each connected via a hinge to a base are selectively movable about the hinge between a use position, in which the wall is generally perpendicular to the base, and a collapsed position onto the base. Various latch mechanisms have been provided to connect adjacent walls at the corner to selectively lock the crate in the use position.

Some collapsible crates also include retractable supports so that another container can be supported thereon. One such crate includes end walls each having a support that is partially supported on the adjacent walls when in the support position. As the end walls are pivoted to the upright position, a biasing member on the support contacts a portion of the adjacent wall to automatically move the support to the support position. However, the biasing members are subject to breakage and require an additional element.

### SUMMARY OF THE INVENTION

The present invention provides a collapsible container having a plurality of walls collapsible onto the base. At least one wall has a support pivotably mounted proximate an upper end thereof. The support is pivotable between a support position where it can support another (dissimilar) container thereon and a retracted position aligned with the wall. A latch assembly connects the wall to an adjacent wall. A resilient portion of the latch assembly also urges the support from the retracted position toward the support position.

When the latch is released, the support can be freely returned to the retracted position against the wall. Therefore, the wall can be collapsed onto the base without having to overcome the force of a biasing member to position the support against the wall.

In the particular embodiment shown, the supports are formed on short end walls of the container, such that the supports and end walls can be collapsed onto the base and the long side walls can be pivoted onto the end walls. Alternatively, the supports could be formed on the long walls (or on equally-sized walls).

### BRIEF DESCRIPTION OF THE DRAWINGS

FIG. 1 is a perspective view of the container in an assembled position.

FIG. 2 is a perspective view of the container of FIG. 1 in a collapsed position.

FIG. 3 is a quarter view of the container of FIG. 1.

FIG. 4 is an enlarged view of one end of one of the side walls of the container of FIG. 1.

FIG. 5 is an enlarged view of one end of one of the end walls of the container of FIG. 1, without the support.

FIG. 6 is an enlarged view of one end of one of the supports of FIG. 1.

FIG. 7 illustrates the end wall of FIG. 5 with the support of FIG. 6 in the retracted position.

FIG. 8 is an interior view of one corner of the container of FIG. 1 with the support in the retracted position.

FIG. 9 is a side view of one end of the container of FIG. 8, with the side wall shown transparent.

FIG. 10 is a view similar to that of FIG. 9, with the support in the support position.

### DETAILED DESCRIPTION OF THE PREFERRED EMBODIMENTS

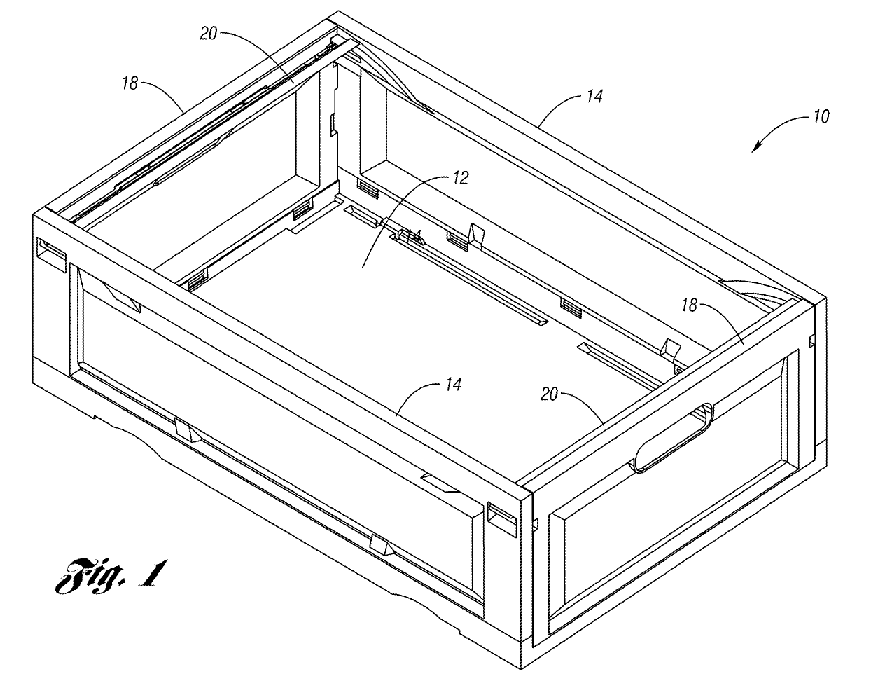

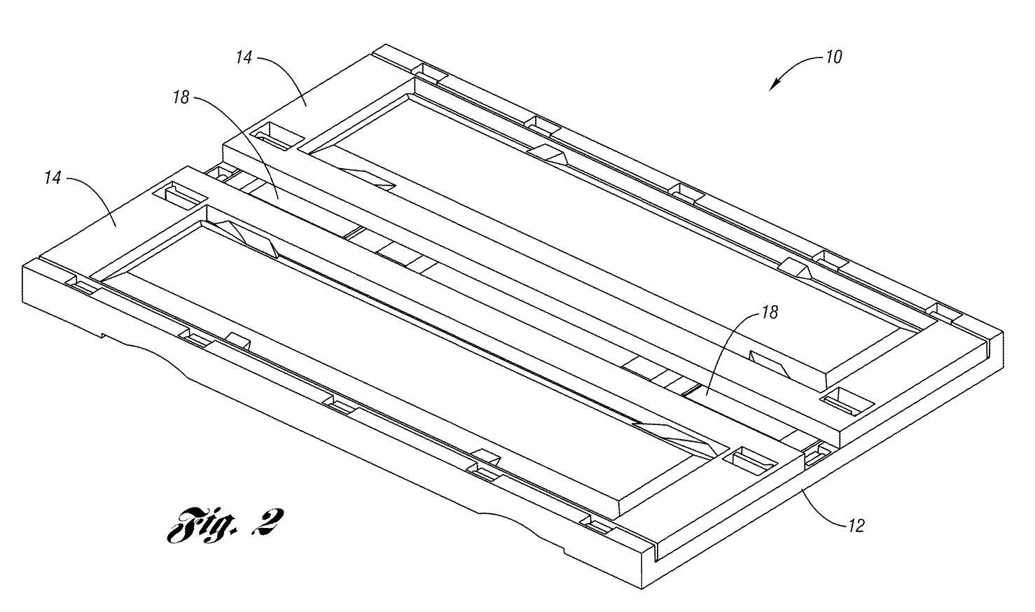

FIG. 1 is a perspective view of a container 10 according to one embodiment of the present invention in an upright, assembled, use position. The container 10 includes a base 12, upstanding side walls 14 (or long walls) and upstanding end walls 18 (or short walls). The side walls 14 and end walls 18 are pivotably connected along long and short edges of the base 12, respectively. Each end wall 18 has a support 20 pivotably connected near an upper end. The side walls 14 and end walls 18 are movable between the upright position shown in FIG. 1 and a collapsed position shown in FIG. 2, with the end walls 18 collapsed onto the base 12 and the side walls 14 collapsed onto the end walls 18.

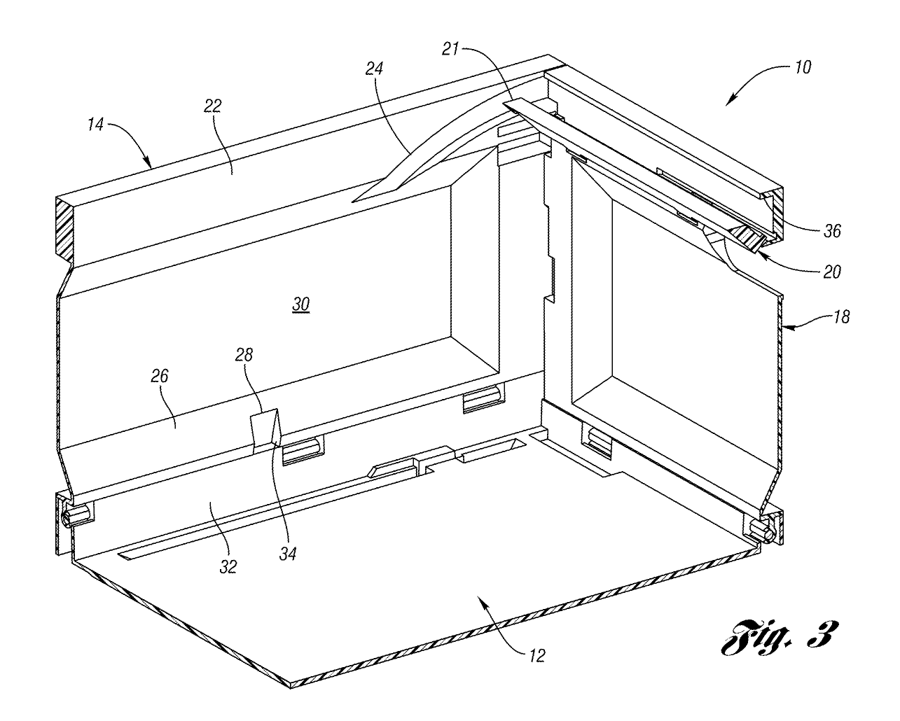

FIG. 3 is an interior view of a quarter of a container 10. The other quarters would be symmetric. The support 20 is pivotably mounted at its lower edge to a position spaced below an upper edge of the end wall 18. The support 20 is shown in FIG. 3 pivoted to a support position, where it projects into the interior of the container 10 where it can support another (dissimilar) container stacked thereon (e.g. a nestable container with a base that is smaller than the mouth formed by the end walls 18 and side walls 14). The supports 20 each include a lateral projection or tab 21 projecting from each side into the adjacent side wall 14. The end walls 18 each include a lip 36 protruding inwardly from the uppermost edge above the support 20. Other arrangements and designs of retractable supports 20 could also be used.

The interiors of the side walls 14 each include an upper frame portion 22 protruding into the container 10. A curved channel 24 is formed through each upper frame portion 22 adjacent the end wall 18. The interior of each side wall 14 further includes a lower frame portion 26 having a channel 28 formed therethrough below each curved channel 24. A recess 30 is defined between the upper frame portion 22 and the lower frame portion 26. The base 12 includes a pair of side upstanding portions 32 to which the side walls 14 are pivotably attached. Each side upstanding portion 32 includes a channel 34 formed on an interior thereof, below each channel 28. The channels 24, 28 and 34 are aligned with one another and with the tabs 21 on the supports 20, so that the end walls 18 can be pivoted to the collapsed position. The side walls 14 do not have to have a recess 30, as long as the support 20 is able to be collapsed. For example, the side walls 14 could simply include a continuous channel to accommodate the tabs 21 of the supports 20.

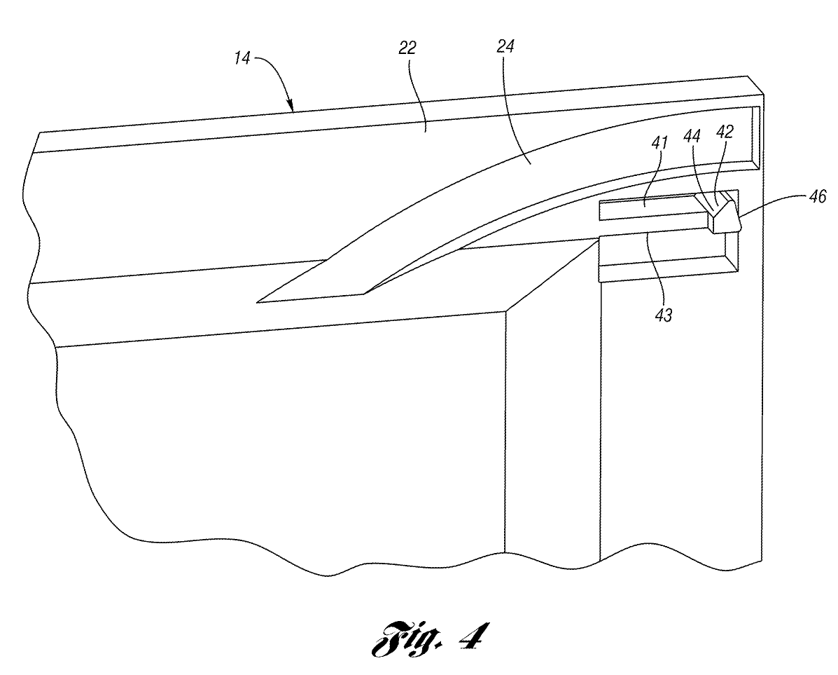

FIG. 4 illustrates one end of one of the side walls 18. At each end the side wall 18 includes a latch 41 having a latch member 42 protruding laterally from the end of a cantilevered flexible arm 43, all integrally molded with the side wall 18. The latch member 42 includes a forward ramped first surface 44 and a rearward ramped second surface 46. The first surface 44 is sloped much more gradually than the second surface 46.

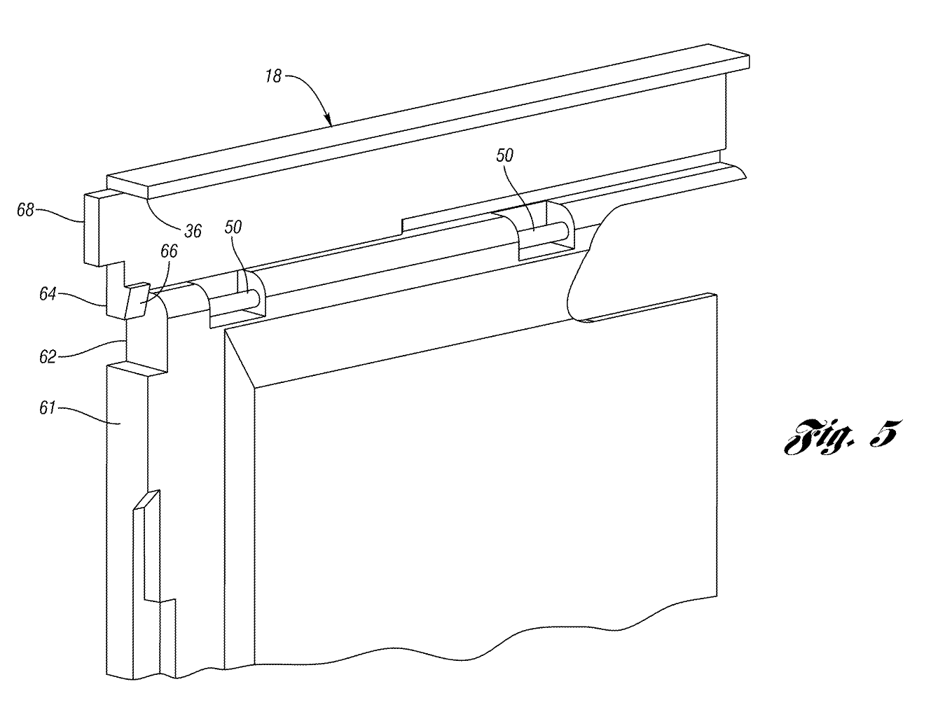

FIG. 5 is an interior view of one end of one of the end walls 18, without the support 20 (FIG. 3). End wall 18 includes a side edge 61 into which is formed a recess 62. Adjacent recess 62, there is formed a forward ramped first surface 64 and a rearward ramped second surface 66. A plurality of hinge pins 50 are integrally molded with the end wall 18. The end wall 18 includes a lateral projection 68 above the recess 62.

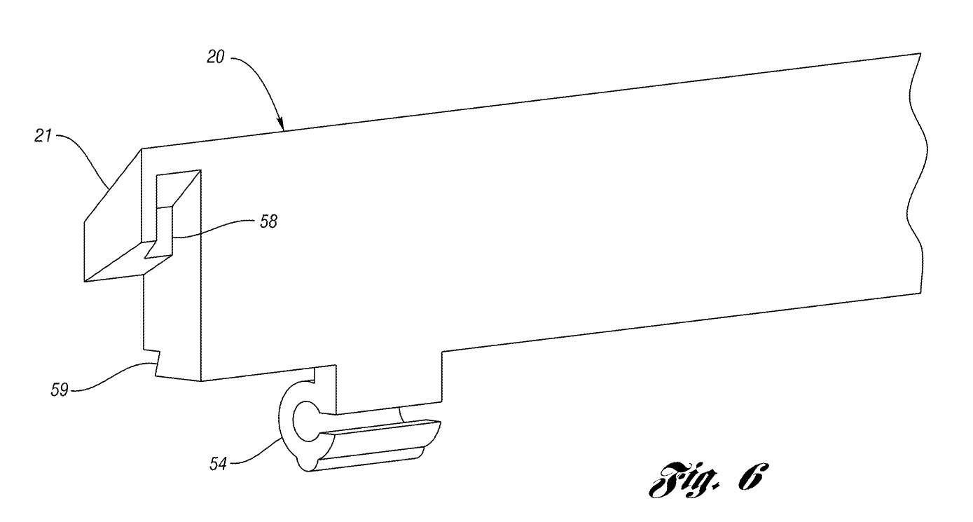

FIG. 6 is an interior view of one end of the support 20. The support 20 includes a plurality of integrally molded hinge receivers 54 (one shown). The tab 21 has a recess 58 formed on an interior surface thereof. The support 20 further includes a rear recess 59.

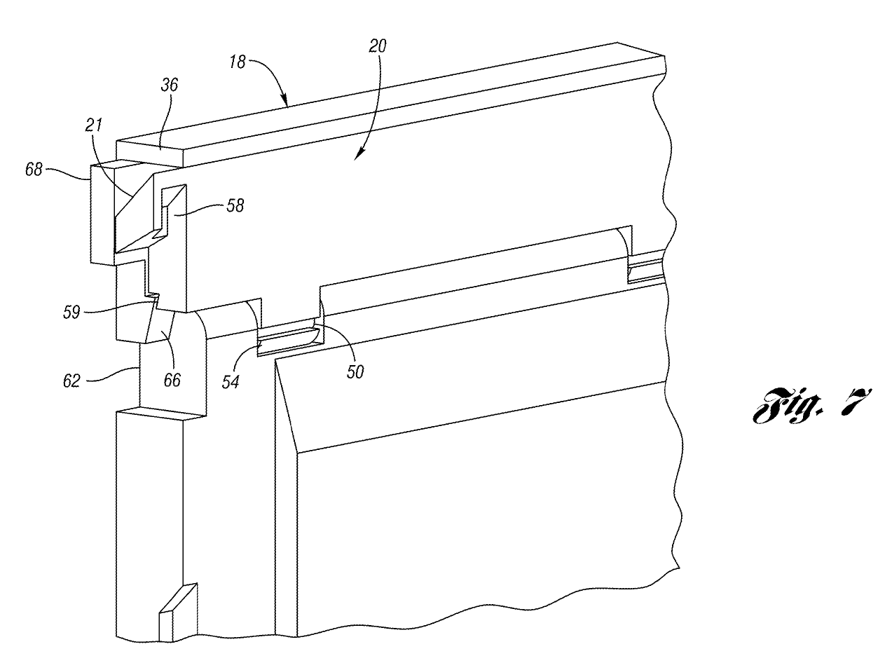

FIG. 7 illustrates the support 20 of FIG. 6 assembled into the end wall 18 of FIG. 5. The hinge pins 50 of the end wall 18 are snap-fit into the hinge receivers 54 of the support 20 to pivotably connect the support 20 to the end wall 18. In the retracted position as shown, the support 20 is partially received within the end wall 18 below the lip 36 of the end wall 18 and a portion of the second rearward ramped surface 66 is received in the rear recess 59 of the support 20. The tab 21 of the support 20 is aligned with the lateral projection 68 of the end wall 18.

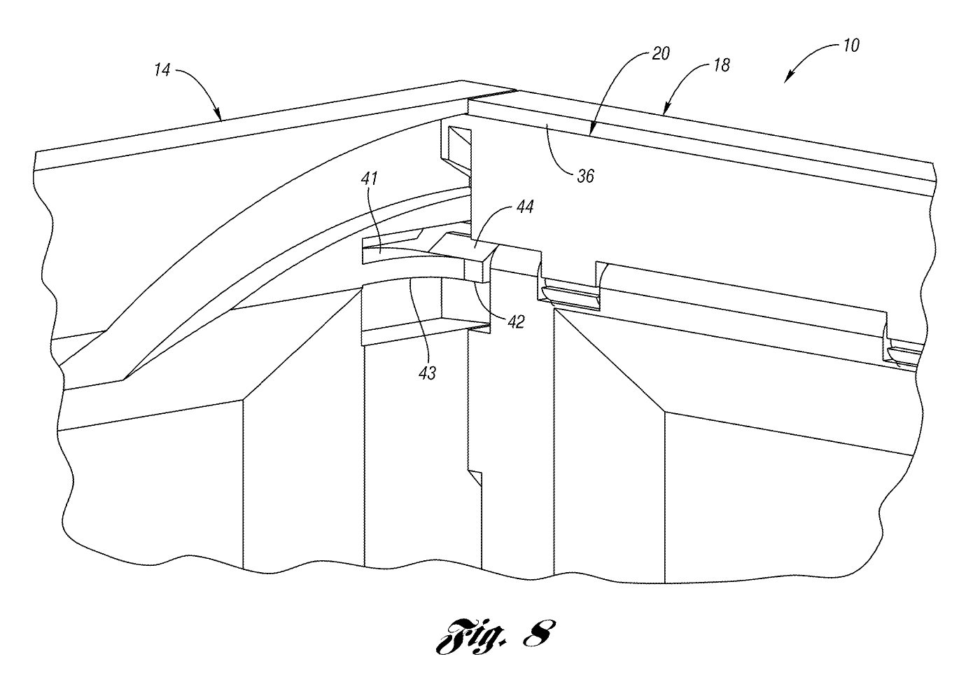

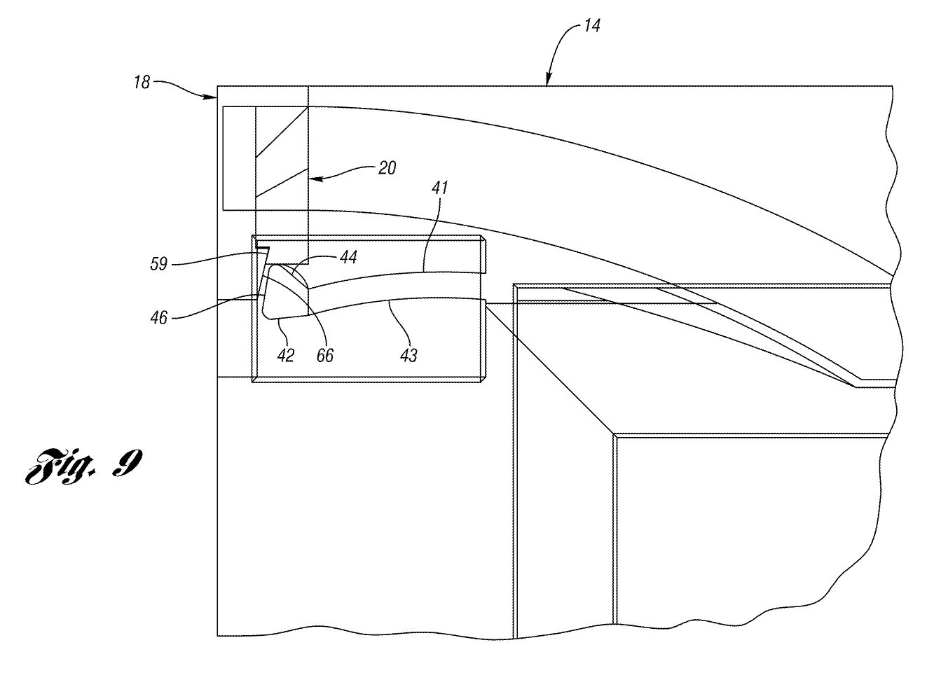

FIG. 8 is an interior view and FIG. 9 is a side view (partially broken away) of the container 10 with the support 20 forced into the retracted position. When the support 20 is moved to this position, the lower surface of the support 20 contacts the first surface 44 of the latch member 42, causing the latch member 42 to move downwardly, thereby flexing the cantilevered arm 43 downwardly. Although flexed downwardly slightly, the latch member 42 is still close to the second surface 66 of the end wall 18 to retain the walls 14, 18 in a latched condition. Additionally, the force needed to keep the support 20 in the retracted position also keeps the end wall 18 in the upright position, even if the latch member 42 does not contact the second surface 66 of the end wall 18.

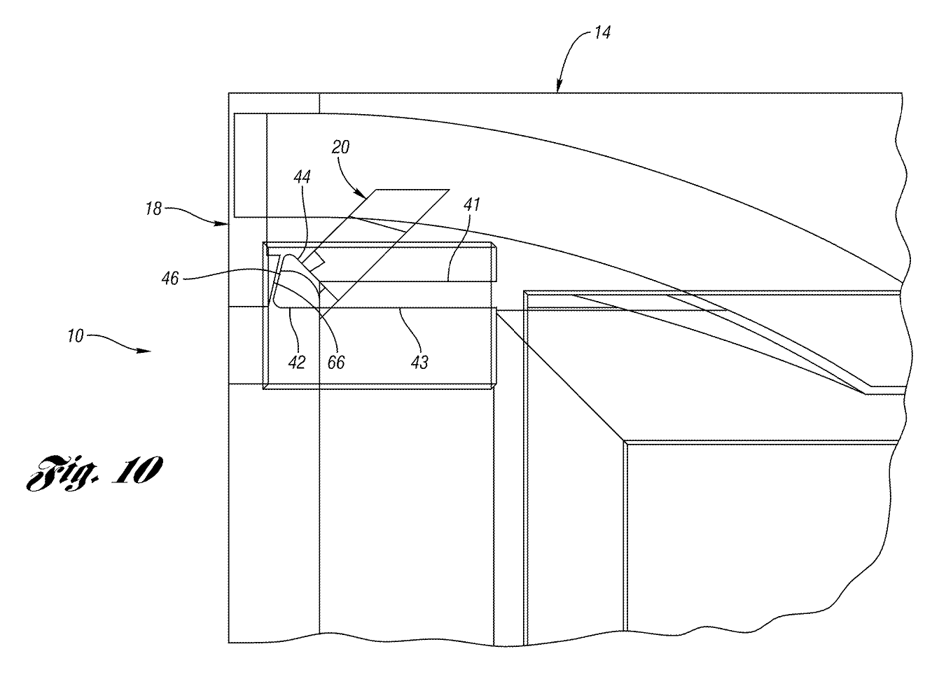

In this position, the latch member 42 biases the support 20 toward the support position. If released, the support 20 will move to the support position as shown in FIG. 8 where it can be used to support another (dissimilar) container. FIG. 10 is a side view, partially transparent, of the container 10, where the first surface 44 bears against the underside of the support 20, thereby moving the support 20 to the support position, as shown.

To collapse the walls, the latch member 42 is depressed downwardly by hand to release the end wall 18. Alternatively, the end wall 18 can be simply knocked down, in which case, the relative inclines of the ramped second surface 66 against the ramped second surface 46 of the latch member 42 causes the latch member 42 to deflect downwardly, thereby releasing the latch 41. The tab 21 of the support 20 and the lateral projection 68 of the end wall 18 pass through the channels 24, 28 and 34 in the side wall 14, so that the end wall 18 can be pivoted to the collapsed position on the base 12. When the latch is released, the support 20 can be freely returned to the retracted position against the wall 18. Therefore, the wall 18 can be collapsed onto the base 12 without having to overcome the force of the latch to position the support 20 against the wall 18.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, in any of the occurrences above, the hinge members and hinge pins could be reversed and formed on opposite parts. Alphanumeric identifiers on method steps are for convenient reference in dependent claims and do not signify a required sequence of performance unless otherwise indicated in the claims.

What is claimed is:

1. A container comprising:
a base;
a first wall pivotably mounted relative to the base;
a second wall pivotably mounted relative to the base, adjacent the first wall;
a latch selectively connecting the first wall to the second wall; and
a support pivotably mounted to the first wall, the support pivotable about an axis generally parallel to the base between a support position and a retracted position, the latch biasing the support from the retracted position toward the support position.

2. The container of claim 1 wherein the support includes a lateral projection into a channel in the second wall.

3. The container of claim 1 wherein the support is pivotably mounted to the first wall at a lower end of the support.

4. The container of claim 1 wherein the support moves the latch toward an unlatched position when the support is moved to the retracted position.

5. The container of claim 1 wherein the latch includes a cantilevered flexible arm integrally molded with the second wall.

6. The container of claim 5 wherein the latch includes a latch member protruding laterally from the flexible arm, the latch member engaging the support.

7. The container of claim 6 wherein the latch member includes a forward ramped first surface, the first surface engaging the support as the support is moved toward the retracted position.

8. The container of claim 7 wherein the latch member includes a rearward ramped second surface engaging the first wall when the latch is in the latched position and wherein the first surface is sloped more gradually than the second surface.

9. The container of claim 1 wherein the latch does not engage the support when the first wall is pivoted away from an upright position.

10. The container of claim 9 wherein the latch does not engage the support when the first wall is in a collapsed position.

11. The container of claim 1 wherein the support extends into a mouth of the container more when in the support position than when in the retracted position.

12. A method of assembling a collapsible container including the steps of:
a) pivoting a first wall relative to a base toward an upright position adjacent a second wall;
b) deploying a support from a retracted position to a support position during said step a) by a latch contacting the support; and
c) engaging the latch to connect the first wall to the second wall.

13. The method of claim 12 wherein the latch is integrally molded with the second wall.

14. The method of claim 12 further including the step of releasing the latch to disconnect the first wall from the second wall, after said steps a-c), so that the first wall can be pivoted toward a collapsed position on the base.

15. The method of claim 12 wherein the support is moved toward an interior of the container during said step b).
